(19) United States
(12) Patent Application Publication
(10) Pub. No.: US 2012/0229505 A1
(43) Pub. Date: Sep. 13, 2012

(54) INFORMATION DISPLAY APPARATUS, AND METHOD AND PROGRAM FOR INFORMATION DISPLAY CONTROL

(75) Inventor: Koji Kuga, Kawasaki-Shi (JP)

(73) Assignee: JVC KENWOOD Corporation, Yokohama-Shi (JP)

(21) Appl. No.: 13/479,604

(22) Filed: May 24, 2012

(30) Foreign Application Priority Data
Nov. 26, 2009 (JP) 2009-268637
Aug. 18, 2010 (JP) 2010-183193
Sep. 17, 2010 (JP) PCT/JP2010/066164

(51) Int. Cl. G09G 5/00

(52) U.S. Cl. 345/629

(57) ABSTRACT

An information display apparatus includes an operation section, a content-related operation log acquisition section, a display section, and a controller. The operation section performs a content-related operation related to each of a plurality of types of content. The acquisition section acquires a content-related operation log as associated with each content for which the content-related operation is being performed and with a type of each content. The operation log includes a move log having position information on a position of the information display apparatus and time information on time during performance of the content-related operation. The display section displays map information based on the position information and an icon on the displayed map information based on the operation log. The icon represents the type of each content. The controller controls the operation section to perform the content-related operation related to each content when an instruction is given to the displayed icon.

### CROSS-REFERENCE TO RELATED APPLICATIONS

This application is a continuation of International Application No. PCT/JP2010/066164 filed on Sep. 17, 2010, based on and claims the benefit of priority from the prior Japanese Patent Application Nos. 2009-268637 filed on Nov. 26, 2009 and 2010-183193 filed on Aug. 18, 2010, and the entire content of which is incorporated herein by reference.

### BACKGROUND OF THE INVENTION

The present invention relates to an information display apparatus, and a method and a program for information display control.

Most recent mobile devices, such as a mobile phone, a PDA (Personal Digital Assistant), and a PND (Portable Navigation Device) are a multifunction device having several functions. The functions are, for example, still-image photographing/reproduction, video recording/reproduction, audio-data recording/reproduction, calling/communications over a telephone network/wireless communications network, e-mail communications, and navigation.

For such a multifunction device, a known technique enables display of position information for each of several pieces of content, in addition to map information. However, no technique is proposed for simultaneously displaying records of operations related to a variety of types of content on a map.

However, recent computers, mobile devices, etc. having several functions can process a variety of types of content. Therefore, it is very useful to simultaneously display records of operations related to a variety of types of content on a map.

### SUMMARY OF THE INVENTION

A purpose of the present invention is to provide an information display apparatus, and a method and a program for information display control, enabling simultaneous display of records of operations related to a variety of types of content on a map.

The present invention provides an information display apparatus comprising: an operation section configured to perform a content-related operation related to each of a plurality of types of content; a content-related operation log acquisition section configured to acquire a content-related operation log as associated with each content for which the content-related operation is being performed by the operation section and also as associated with a type of the each content, the content-related operation log including a move log having position information on a position of the information display apparatus and time information on time during performance of the content-related operation related to the each content; a display section configured to display map information based on the position information and to display at least an icon on the displayed map information based on the content-related operation log, the icon representing the type of the each content; and a controller configured to control the operation section to perform the content-related operation related to the each content when an instruction is given to the displayed icon.

Moreover, the present invention provides a method for information display control comprising the steps of: performing a content-related operation related to each of a plurality of types of content; acquiring a content-related operation log as associated with each content for which the content-related operation is being performed and also as associated with a type of the each content, the content-related operation log including a move log having position information on a position related to performance of the content-related operation related to each content and time information on time during the performance of the content-related operation related to the each content; displaying map information based on the position information and displaying at least an icon on the displayed map information based on the content-related operation log, the icon representing the type of the each content; and initiating the performance of the content-related operation related to the each content when an instruction is given to the displayed icon.

Furthermore, the present invention provides a program for information display control stored in a non-transitory computer readable storage medium, the program comprising: a program code of performing a content-related operation related to each of a plurality of types of content; a program code of acquiring a content-related operation log as associated with each content for which the content-related operation is being performed and also as associated with a type of the each content, the content-related operation log including a move log having position information on a position related to performance of the content-related operation related to each content and time information on time during the performance of the content-related operation related to the each content; a program code of displaying map information based on the position information and displaying at least an icon on the displayed map information based on the content-related operation log, the icon representing the type of the each content; and a program code of initiating the performance of the content-related operation related to the each content when an instruction is given to the displayed icon.

### BRIEF DESCRIPTION OF DRAWINGS

FIG. 1 is a view showing a block diagram of a information display apparatus, an embodiment according to the present invention;

FIG. 2 is a view showing a flow chart of an operation of content-related operation log recording to be performed by the information display apparatus shown in FIG. 1;

FIG. 3 is a view showing a flow chart of a content-related operation to be performed by the information display apparatus shown in FIG. 1;

FIG. 4 is a view showing a flow chart of a content-related operation with display of an action log for a specific term to be performed by the information display apparatus shown in FIG. 1;

FIG. 5 is a view showing an example 1 of a display to be displayed on a display unit of the information display apparatus shown in FIG. 1, based on content-related operation logs;

FIG. 6 is a view showing an example related to the example 1 of FIG. 5, in which an icon corresponding to one of the content-related operation logs is selected;

FIG. 7 is a view showing an example 2 of a display to be displayed on the display unit of the information display apparatus shown in FIG. 1, based on content-related operation logs;

FIG. 8 is a view showing an example 3 of a display to be displayed on the display unit of the information display apparatus shown in FIG. 1, based on content-related operation logs;

FIG. 9 is a view showing an example 4 of a display to be displayed on the display unit of the information display apparatus shown in FIG. 1, based on content-related operation logs;

FIG. 10 is a view showing an example 5 of a display to be displayed on the display unit of the information display apparatus shown in FIG. 1, based on content-related operation logs;

FIG. 11 is a view showing an example 6 of a display to be displayed on the display unit of the information display apparatus shown in FIG. 1, based on content-related operation logs;

FIG. 12 is a view showing an example 7 of a display to be displayed on the display unit of the information display apparatus shown in FIG. 1, based on content-related operation logs;

FIG. 13 is a view showing an example 8 of a display to be displayed on the display unit of the information display apparatus shown in FIG. 1, based on content-related operation logs;

FIG. 14 is a view showing an example 9 of a display to be displayed on the display unit of the information display apparatus shown in FIG. 1, based on content-related operation logs;

FIG. 15 is a view showing an example 10 of a display to be displayed on the display unit of the information display apparatus shown in FIG. 1, based on content-related operation logs; and

FIG. 16 is a view showing an example 11 of a display to be displayed on the display unit of the information display apparatus shown in FIG. 1, based on content-related operation logs.

### DETAILED DESCRIPTION OF PREFERRED EMBODIMENTS

Embodiments of an information display apparatus, and a method and a program for information display control according the present invention will be explained with reference to the attached drawings. Throughout the drawings, the same reference numerals or signs are given to the same or analogous elements, hence a duplicate explanation thereof will be omitted.

(Configuration of Information Display Apparatus)

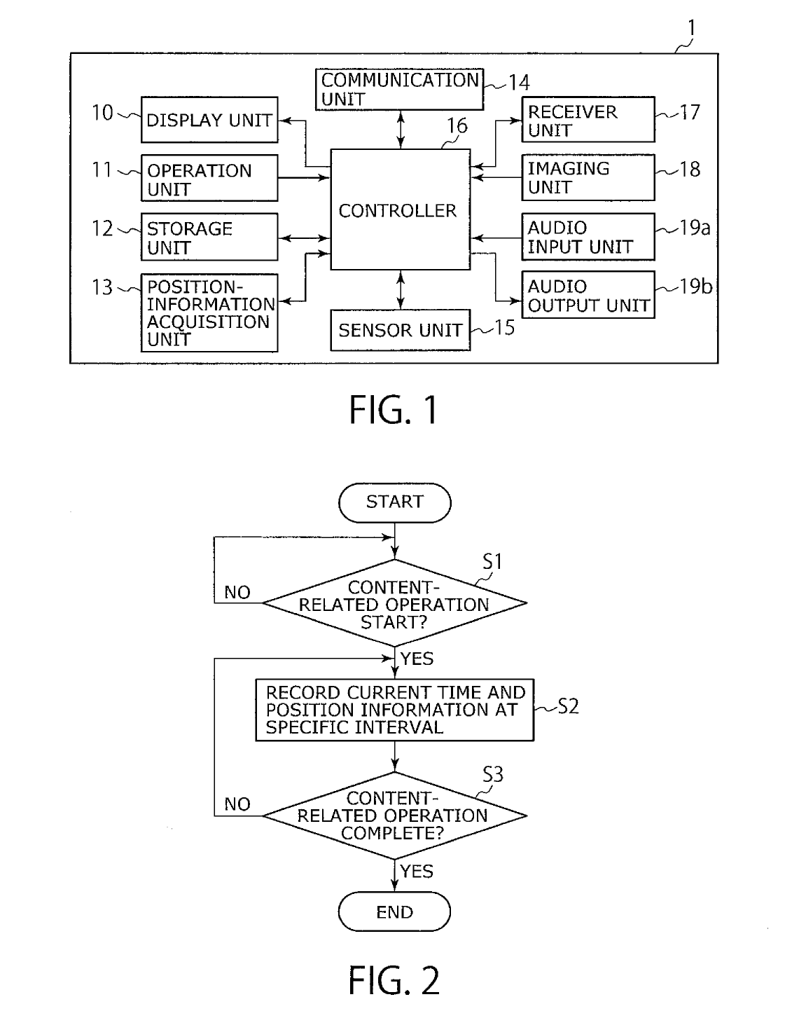

The configuration of an information display apparatus 1, an embodiment according to the present invention will be described with respect to FIG. 1.

FIG. 1 is a view showing a block diagram of the information display apparatus 1. As shown in FIG. 1, the information display apparatus 1 is provided with a display unit 10, an operation unit 11, a storage unit 12, a position-information acquisition unit 13, a communication unit 14, a sensor unit 15, a controller 16, a receiver unit 17, an imaging unit 18, an audio input unit 19a, and an audio output unit 19b.

With co-operation of these units under control by the controller 16, the information display apparatus 1 according to the present invention can function as a mobile phone, a PDA (Personal Digital Assistant), a PND (Portable Navigation Device), etc. that can be carried by a user or installed in a vehicle as an in-vehicle apparatus.

The display unit 10 displays a variety of types of information (text information, image information, etc.) under control by the controller 16. The display unit 10 is equipped with a display device such as a liquid crystal display device or an organic electro luminescence display device.

The operation unit 11 accepts a user operation to the controller 16, which will be described later. The operation unit 11 is equipped, for example, with a touch panel that is provided on the display unit 10 so that a display created on the display unit 10 can be viewed through the panel. A user operation to the controller 16 is made when a user depresses, with a finger or the like, a zone of the touch panel corresponding to an icon displayed on the display unit 10. The touch panel may be a matrix switch type, a resistive film type, a surface acoustic wave type, an infrared ray type, an electromagnetic induction type, an electrostatic type, etc. The operation unit 11 may be equipped with switches such as button switches and key switches. Or the operation unit 11 may have a pointing function (a function of pointing a specific position on the screen of the display unit 10).

The storage unit 12 stores information sent from the controller 16 and retrieves information already stored and sends it to the controller 16. The storage unit 12 is equipped, for example, with an HDD (Hard Disk Drive) or a non-volatile memory such as a flash memory and a ROM (Read Only Memory) that can hold information irrespective of the ON/OFF mode of the information display apparatus 1. In addition to an HDD or a non-volatile memory, the storage unit 12 may be equipped with a RAM (Random Access Memory) as a temporary memory. Or the storage unit 12 may be equipped with an interface to be connected to an external storage device such as an SD (Secure Digital) card and a USB (Universal Serial Bus) memory.

The position-information acquisition unit 13 is equipped, for example, with a GPS (Global Positioning System) device that receives GPS signals from GPS satellites to measure the current position of the information display apparatus 1. In addition to a GPS device, the position-information acquisition unit 13 may be equipped with any type of device that can measure the current position of the information display apparatus 1, for its multifunction. For example, when the information display apparatus 1 functions as a mobile phone, it can receive information on the position of a base station from which the information display apparatus 1 is currently receiving a signal through the communication unit 14 to estimate its own current position.

The communication unit 14 can be modified to have a variety of functions, as explained below.

When the information display apparatus 1 receives content from a broadcasting station (not shown) or an Internet website (not shown), the communication unit 14 functions as a content receiver, such as a wireless LAN (Local Area Network) device. When the information display apparatus 1 is used as a mobile phone, the communication unit 14 functions as a communication controller for telephone or e-mail communications with a base station in a mobile phone system, for data communications over a mobile phone network, etc. Moreover, the communication unit 14 functions as a communication controller for communications with an information provider (a server, not shown) that provides information to the information display apparatus 1, over a network, or for telephone communications, mail communications, etc. over a network. Furthermore, when the information display apparatus 1 is installed in a vehicle as an in-vehicle apparatus, the communication unit 14 functions as a communication controller for Bluetooth (a registered trademark) communications, for example.

The sensor unit 15 is equipped with at least one sensor among an acceleration sensor (for attitude detection), a gyro sensor (for detection of change in detection), a geomagnetic sensor (for direction detection), a luminance sensor (for detection of surrounding brightness), a temperature sensor, etc. An acceleration sensor and a gyro sensor may be installed in the sensor unit 15 for complementing position information on the current position of the information display apparatus 1 acquired by the position-information acquisition unit 13, for higher accuracy. Nevertheless, the sensor unit 15 is not an essential element for the information display apparatus 1 in this embodiment.

The controller 16 is equipped with a CPU (Central Processing Unit), an ASIC (Application Specific Integrated Circuit), a microprocessor (microcomputer), a DSP (Digital Signal Processor), etc. The controller 16 has a function of controlling the several units that constitute the information display apparatus 1, such as control of: the display unit 10 to display information; the operation unit 11 to accept a user operation; the storage unit 12 to store and retrieve information; the position-information acquisition unit 13 to acquire information on the current position of the information display apparatus 1; the communication unit 14 for communication; the sensor unit 15 to detect a variety of types of data and send them to the controller 16; the receiver unit 17 to receive a broadcast program; and the imaging unit 18 to capture an image and send it to the sensor unit 15. Moreover, the controller 16 has functions of decoding and other processes to audio data input via the audio input unit 19a, and encoding and other processes to audio data output via the audio output unit 19b. Moreover, the controller 16 has a function of text-information creation, which will be described later.

The receiver unit 17 is equipped with a tuner to tune to a broadcast program, such as a radio tuner to tune to a broadcast radio program or a TV tuner to tune to a broadcast TV program, through analog or digital broadcasting. The receiver unit 17 may further be equipped with an antenna for analog or digital broadcasting. It is also preferable to have a function of receiving a broadcast radio or TV program over an IP (Internet Protocol) network. In this case, the communication unit 14 functions as the receiver unit 17.

The imaging unit 18 is equipped with optical components such as lenses and an imaging device, for example, a CCD (Charge Coupled Devices). The imaging unit 18 captures light incident on the lenses as image data under control by the controller 16. When image data captured by the imaging unit 18 is video data of continuous images, the controller 16 encodes the video data in a specific video-data compression mode. On the other hand, when image data captured by the imaging unit 18 is still-image data, the controller 16 encodes the still-image data in a specific still-image-data compression mode. It is also preferable to encode audio data input via the audio input unit 19a, in addition to the video or still-image data.

The audio input unit 19a is equipped, for example, with an audio input terminal or a microphone built in the information display apparatus 1. An external microphone (not shown) may be connected to the audio input unit 19a. The audio input unit 19a sends input audio data to the controller 16. The audio input unit 19a may also be equipped with an ADC (Analog-to-Digital Converter) to convert an analog input signal to a digital signal that is then sent to the controller 16.

The audio output unit 19b is equipped, for example, with an audio output terminal or a speaker installed in the information display apparatus 1. The audio output unit 19b outputs a sound reproduced under control by the controller 16 or a sound of a broadcast program received by the receiver unit 17. The audio output unit 19b may also be equipped with a DAC (Digital-to-Analog Converter) to convert a digital audio signal to an analog audio signal and output the analog audio signal.

The several units of the information display apparatus 1 described above work together depending on the type of content desired by a user. Several units that work together for specific content constitute an operation section that performs a specific operation related to the specific content, according to the present invention. Which units constitute the operation section depends on the type of content desired by a user. Several combinations of the units that work together as the operation section will be described for some examples of content.

(Broadcast Content Data)

In order for the operation section according to the present invention to record broadcast content data, the receiver unit 17 (or the communication unit 14) for receiving broadcast content and the storage unit 12 work together as the operation section, under control by the controller 16.

(Audio or Video Content Data Stored in Storage Unit 12)

In order for the operation section according to the present invention to reproduce audio content data (stored in the storage unit 12), the storage unit 12 and the audio output unit 19b work together as the operation section, under control by the controller 16. In order for the operation section to reproduce video content data (stored in the storage unit 12), the storage unit 12, the audio output unit 19b, and the display unit 10 work together as the operation section, under control by the controller 16.

(Audio Content Data to be Recorded)

In order for the operation section according to the present invention to record audio content data, the audio input unit 19a, and the storage unit 12 work together as the operation section, under control by the controller 16.

(Video or Still-Image Content Data to be Captured)

In order for the operation section to capture video content data, the imaging unit 18, the audio input unit 19a, and the storage unit 12 work together as the operation section, under control by the controller 16. In order for the operation section to capture still-image content data, the imaging unit 18 and the storage unit 12 work together as the operation section, under control by the controller 16.

(Broadcast Content Data)

In order for the operation section according to the present invention to receive broadcast content data, the receiver unit 17 and the audio output unit 19b work together as the operation section, under control by the controller 16. The display unit 10 is added to these units when the broadcast content is TV broadcast content. The receiver unit 17 is replaced by the communication unit 14 when receiving broadcast content over an IP network.

(Application Software Content)

In order for the operation section according to the present invention to run application software content, the storage unit 12 and other necessary additional units (depending on the type of application software content) work together as the operation section, under control by the controller 16. The application software in this example is not application software that automatically runs on the information display apparatus 1 but those to be started and run by a user operation, such as spreadsheet software and game software. The necessary additional units for application software content, in addition to the storage unit 12, depend on the type of application software content. The necessary additional units include the operation unit 11 when a user operation or input is required. Application software may be pre-stored in the storage unit 12. The communication unit 14 is added to those units mentioned above when downloading application software over a network.

(E-Mail Content over IP Network)

In order for the operation section according to the present invention to send or receive an e-mail over an IP network or the like, the communication unit 14 works as the operation section, under control by the controller 16.

(Call Content)

In order for the operation section according to the present invention to make or receive a call over a telephone network or an IP network, the communication unit 14, the audio input unit 19a, and the audio output unit 19b work together as the operation section, under control by the controller 16.

In addition to the operation section that performs a specific operation related to each of a plurality of types of content described above, the present invention includes the following sections. A specific operation related to each of a plurality of types of content, such as reproduction of audio content data, is referred to as a content-related operation, hereinafter.

One section included in the present invention is a content-related operation log acquisition section that acquires a content-related operation log as associated with each content for which the content-related operation is being performed by the operation section and also as associated with a type of the each content, the content-related operation log including a move log having position information on a position of the information display apparatus 1 and time information on time during performance of the content-related operation related to the each content. The position-information acquisition unit 13 and the storage unit 12 (and the sensor unit 15 if necessary for higher accuracy of position-information acquisition) work together as the content-related operation log acquisition section, under control by the controller 16.

Another section included in the present invention is a display section that displays map information based on the position information and to display at least an icon on the displayed map information based on the content-related operation log, the icon representing the type of the each content. The display unit 10 and the storage unit 12 work together as the display section, under control by the controller 16.

Under control by the controller 16, the operation section performs the content-related operation related to the each content when an instruction (a user operation through the operation unit 11) is given to the displayed icon.

The content-related operation log acquisition section and the display section will be described later in detail.

(Content-Related Operation Log Recording)

Described next with reference to a flow chart of FIG. 2 is an operation of content-related operation log recording to be performed by the controller 16 of the information display apparatus 1.

Start: The controller 16 moves onto step S1 when the information display apparatus 1 is turned on.

Step S1: The controller 16 determines whether an operation related to content (a content-related operation) has started. If it is determined that a content-related operation has started (Yes in step S1), the controller 16 moves onto step S2. On the other hand, if it is determined that no content-related operation has started (No in step S1), the controller 16 repeats step S1 until it is determined that a content-related operation has started.

Step S2: The controller 16 records the current time and the current position of the information display apparatus 1 in the storage unit 12 at a specific interval. In this case, the current time information and the current position information are recorded in the storage unit 12, as associated with content for which a content-related operation is now being performed. The information recorded in the storage unit 12 is referred to as content-related operation information, hereinafter. The controller 16 moves onto step S3 while performing the recording in step S2. The controller 16 can acquire the current time information and the current position information from a clock (not shown) built in the controller 16 and the position-information acquisition unit 13, respectively.

Step S3: The controller 16 determines whether the content-related operation determined as started in step S1 is completed. If it is determined that the content-related operation is complete (Yes in step S3), the controller 16 finishes (END) the operation of content-related operation log recording. On the other hand, if it is determined that the content-related operation is not complete (No in step S3), the controller 16 repeats step S2 until it is determined that the content-related operation is complete.

In the content-related operation log recording described above, the current time information and the current position information are recorded in the storage unit 12, as associated with content for which a related operation is now being performed. On the other hand, the current time information and the current position information not associated with content may be recorded in the storage unit 12 any time irrespective of whether a content-related operation is being performed. In this case, the current time information and the current position information that have been continuously recorded in the storage unit 12 from before the performance of a content-related operation may be recorded as associated with a content-related operation now being performed. Moreover, the current time information and the current position information not associated with content may also be continuously recorded in the storage unit 12 when the information display apparatus 1 is in a sleep mode (not a turn-on mode).

(Execution of Content-Related Operation)

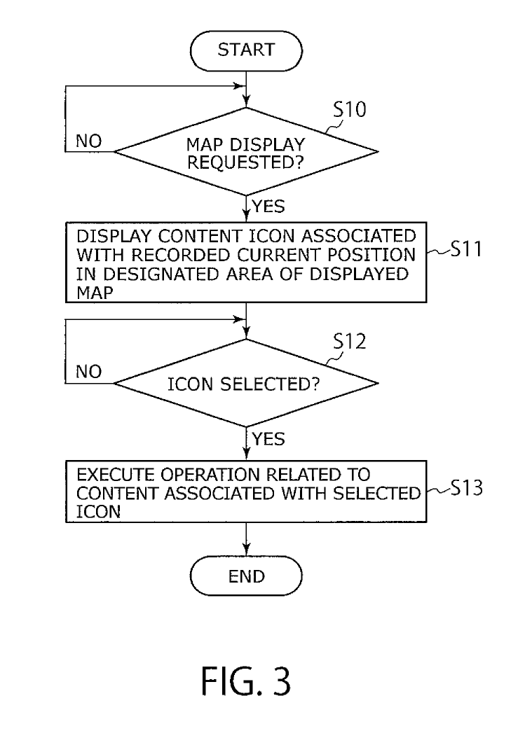

Described next with reference to a flow chart of FIG. 3 is execution of a content-related operation to be performed by the controller 16 of the information display apparatus 1.

Start: The controller 16 moves onto step S10 when the information display apparatus 1 is turned on.

Step S10: The controller 16 determines whether map display is requested through an operation at the operation unit 11. If it is determined that map display is requested (Yes in step S10), the controller 16 displays a map on the display unit 10 and moves onto step S11. On the other hand, if it is determined that map display is not requested (No in step S10), the controller 16 repeats step S10 until it is determined that map display is requested. If Yes in step S10, the controller 16 displays a map on the display unit 10 for an area designated based on the position information (i.e. coordinates information) acquired the position-information acquisition unit 13. Map data pre-stored in the storage unit 12 is retrieved therefrom for use in map display. Not only from the storage unit 12, map data may be acquired, any time according to the necessity, from an external map-data server or the like through the communication unit 14.

Step S11: The controller 16 displays an icon that represents content associated with the current position information recorded in the storage unit 12 in step S2 of FIG. 2, in the area of the map (designated in step S10) on the display unit 10, then moving onto step S12. The data of an icon to be displayed is retrieved from the storage unit 12 in which a variety of icons have been pre-stored as associated with a variety of content. Therefore, the icon to be displayed in step S11 depends on the type of content associated with the position in the area of the map displayed on the display unit 10.

Step S12: The controller 16 determines whether the icon displayed on the display unit 10 in step S11 is selected through an operation at the operation unit 11. If it is determined that the icon is selected (Yes in step S12), the controller 16 moves onto step S13. On the other hand, if it is determined that the icon is not selected (No in step S12), the controller 16 repeats step S12 until the icon is selected. When the displayed icon is selected in step S12, the designated area of the map displayed on the display unit 10 may be enlarged in the vicinity of the selected icon. By viewing the enlarged area on the display unit 10, a user can know exactly where an operation related to the content corresponding to the selected icon was performed.

Step S13: The controller 16 executes an operation related to the content associated with the selected icon and finishes (END) the process of execution of content-related operation. The execution of an operation related to the content associated with a selected icon is, for example, running software such as application software for performing a content-related operation, depending on the type of content, and retrieving files or the like of the content. The type of content is identified with an extension appended to a file name of content or a tag appended to content data, for example.

(Execution of Content-Related Operation with Display of Action Log for Specific Term)

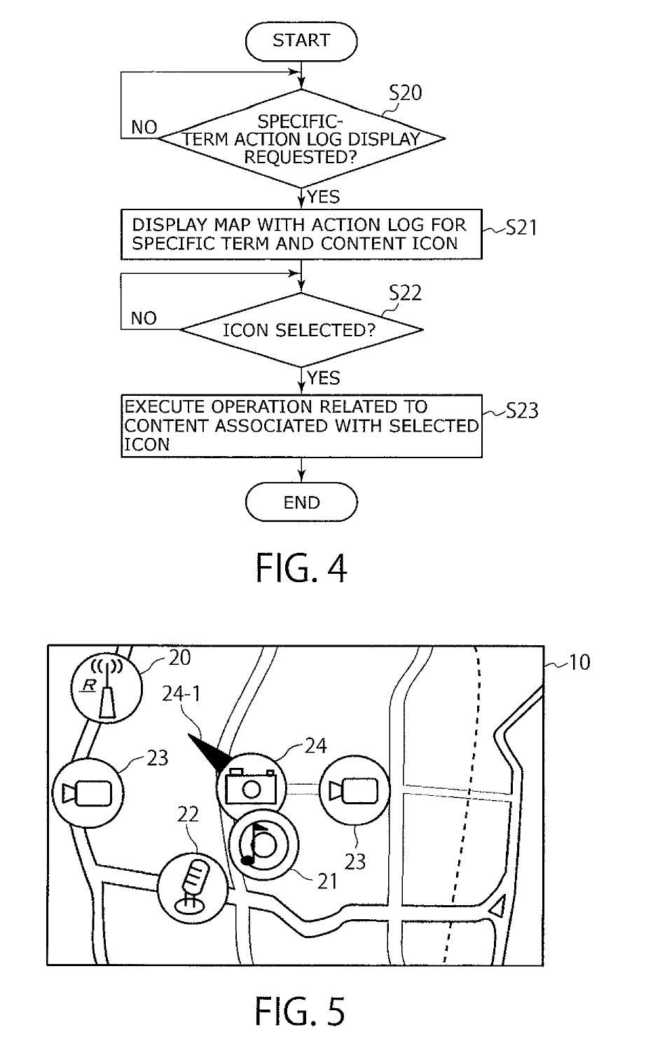

Described next with reference to a flow chart of FIG. 4 is execution of a content-related operation with display of an action log for a specific term to be performed by the controller 16 of the information display apparatus 1. The action log includes an operation log and/or a move log which will be described later.

Start: The controller 16 moves onto step S20 when the information display apparatus 1 is turned on.

Step S20: The controller 16 determines whether display of an action log for a specific term is requested through an operation at the operation unit 11. If it is determined that display of an action log for a specific term is requested (Yes in step S20), the controller 16 moves onto step S21. On the other hand, if it is determined that display of an action log for a specific term is not requested (No in step S20), the controller 16 repeats step S20 until it is determined that display of an action log for a specific term is requested. The specific term in this embodiment may include a time, a date, a week, a month and a year, specified by a user, with a location (a user's home and office, etc.) of the information display apparatus 1, as the starting or end point of the specific term. The specific term can be set by a user by entering a numerical value through the operation unit 11 or by selecting a term from a calendar or diary displayed on the display unit 10.

Step S21: The controller 16 displays a map on the display unit 10 and, in addition, displays an action log for a specific term and an icon corresponding to content on the map, and moves onto step S22. Concerning the scale of a map on the display unit 10, a map having a size that covers the entire action log for a selected specific term is displayed, for example. However, there is a case that an action log includes an action record in a wide area, such as, a country or a state. In this case, a map of a specific area may be displayed, with the starting point in the action log at the center of the displayed area. Or a map of a specific area may be displayed, with a spot for which there are many action logs or content-related operation logs, at the center of the displayed area. A map displayed on the display unit 10 can be scaled up or down through a user operation on the operation unit 11. Moreover, in the case of wide area such as a country or a state, it is also possible that an icon is not be displayed first but displayed later when a map displayed on the display unit 10 is scaled up to a specific area such as a city or a town, through a user operation on the operation unit 11.

Step S22: The controller 16 determines whether the icon displayed on the display unit 10 in step S21 is selected through an operation at the operation unit 11. If it is determined that the icon is selected (Yes in step S22), the controller 16 moves onto step S23. On the other hand, if it is determined that the icon is not selected (No in step S22), the controller 16 repeats step S22 until the icon is selected.

Step S23: The controller 16 executes an operation related to the content associated with the selected icon and finishes (END) the process of execution of a content-related operation with display of an action log for a specific term.

The controller 16 can execute a content-related operation in FIG. 3 or a content-related operation with display of an action log for a specific term in FIG. 4 in parallel with an operation of content-related operation log recording in FIG. 2.

Concerning the content-related operation log recording described with referent to the flow chart of FIG. 2, step S2 will be described in detail.

The controller 16 records operation logs of content-related operations for a variety of types of content, with the types and names (or titles) related to the content, in the storage unit 12. Each operation log includes a content-related operation starting time and position coordinates (such as latitude and longitude) at the starting time. In addition to the starting time and the position coordinates, for content that requires a specific duration for a content-related operation, each operation log includes a content-related start time, a content-related operation complete time and position coordinates while a content-related operation is being executed. Moreover, each operation log includes a use log if obtainable.

Examples of the content-related operation log will be explained.

(1) Broadcast-Content Recording Log

It is defined in this example that broadcast content includes radio and TV broadcast received through the receiver unit 17 and also IP broadcast received through the communication unit 14. It is also defined in this example that broadcast content recording is recording or video recording of received broadcast and storing a file created based on the recording or video recording in the storage unit 12. Log information for a broadcast-content recording log includes a file name of a file created based on the recording or video recording, a time and date of recording or video recording, and a place of recording or video recording. Also included in log information is information that identifies a broadcasting station from which broadcast content is received and recorded, such as, a name of a broadcasting station, a channel number, a frequency, URL (Uniform Resource Locator), etc. When there is a movement during broadcast content recording, a period of time and position coordinates from recording start to completion may also be recorded, with respect to the time and date, and the place of recording or video recording.

(2) Audio- and Video-Content Reproduction Log

It is defined in this example that audio and video content includes content of audio and video data stored in the storage unit 12 or a stream provided over a network and received through the communication unit 14. It is also defined in this example that audio content includes music data for which a user purchases the data itself or a medium, audio data recorded by a user, audio data of radio broadcast or the like recorded by a user, audio data provided over a network, etc. Moreover, it is defined in this example that video content includes video data for which a user purchases the data itself or a medium, video data video-recorded by a user, video data of TV broadcast or the like video-recorded by a user, video data provided over a network, etc. These variety of types of video content may include audio data.

Log information for an audio- and video-content reproduction log includes information, such as, a time and date of reproduction of content, a place (position coordinates) of reproduction of content, a file name, URL, etc. When there is a movement during content reproduction, a period of time and position coordinates from reproduction start to completion may also be recorded, with respect to the time and date, and the place of reproduction. Moreover, when a plurality of pieces of audio or video content are being continuously reproduced, log information may be recorded for each piece of content. For example, when a group of pieces of audio content in an album are being continuously reproduced, an album name may be recorded as log information, instead of a file name. Furthermore, log information may not be recorded for content for which reproduction has started but that is skipped to another piece of content for reproduction, for example, within five seconds.

(3) Audio-Content Recording Log

Audio content in this embodiment is, for example, audio data to be recorded by a user using a microphone of the audio input unit 19a. Log information for an audio-content recording log includes information, such as, a file name of a created file, a time and date of audio content recording, a place (position coordinates) of audio content recording, etc. When there is a movement during recording of audio content, a period of time and position coordinates from recording start to completion may also be recorded, with respect to the time and date, and the place of recording. Moreover, log information may not be recorded for audio content for which recording has started but stopped, for example, within five seconds.

(4) Video-Content Imaging Log

Video content in this embodiment is, for example, video data to be captured by a user using the imaging unit 18 with or without a microphone of the audio input unit 19a. Log information for a video-content imaging log includes information, such as, a file name of a created file, a time and date of imaging, a place (position coordinates) of imaging, etc. When there is a movement during video content imaging, a period of time and position coordinates from imaging start to completion may also be recorded, with respect to the time and date, and the place of imaging. Moreover, log information may not be recorded for video content for which imaging has started but stopped, for example, within five seconds.

(5) Still-Image-Content Imaging Log

Still image content in this embodiment is, for example, still image data to be captured by a user using the imaging unit 18. Log information for a still-image-content imaging log includes information, such as, a file name of a created file, a time and date of imaging, a place (position coordinates) of imaging, etc. Moreover, the log information for a still-image-content imaging log may include an imaging direction (a point of the compass) using a geomagnetic sensor of the sensor unit 15.

(6) Broadcast-Content Reception Log

Log information for a broadcast-content reception log includes a time and date of reception, a place of reception (position information), and also information that identifies a broadcasting station from which broadcast content is received, such as, a name of a broadcasting station, a channel number, a frequency, URL (Uniform Resource Locator), etc. When there is a movement during broadcast content reception, a period of time and position coordinates from reception start to completion may also be recorded, with respect to the time and date, and the place of broadcast content reception. Moreover, log information may not be recorded for broadcast content for which reception has started but stopped or the channel is switched to another, for example, within five seconds.

(7) Application Running Log

The information display apparatus 1 records or keeps a log for running an application stored in the storage unit 12 or an application available from an external server through the communication unit 14, as a content-related operation. An application in this embodiment is, for example, application software, such as word processing software, spreadsheet software and game software. Log information for an application running log includes information, such as, a title of application software run on the information display apparatus 1, a file name of a file created or operated by the application software, a time and date of application running, a place (position coordinates) of application running, etc. When there is a movement during application running, a period of time and position coordinates from running start to completion may also be recorded, with respect to the time and date, and the place of application running.

(8) E-Mail Transmission and Reception Log

The information display apparatus 1 records or keeps a log for e-mail transmission and reception over a telephone network or a wireless LAN (Local Area Network) through the communication unit 14. Content for which a log is kept in this embodiment is, for example, transmitted and received e-mails. Log information for e-mail transmission and reception log includes information that identifies a communication partner who received an e-mail or from whom an e-mail was transmitted, such as an e-mail address or a name. Also included in the log information are a title, a time and date of e-mail transmission and reception, a place (position coordinates) of e-mail transmission and reception, etc.

(9) Communication Log

The information display apparatus 1 records or keeps a log for telephone conversation over a telephone network through the communication unit 14, as a content-related operation. Log information for a communication log includes information that identifies a communication partner, such as a telephone number and a name. Also included in the log information are a time and date of telephone conversation, a place (position coordinates) of telephone conversation, etc. When there is a movement during telephone conversation, a period of time and position coordinates from conversation start to completion may also be recorded, with respect to the time and date, and the place of telephone conversation.

(10) Move Log

In addition to the content-related operation logs for a variety of types of content described above, the information display apparatus 1 may always record or keep a move log including time and positional information whenever the apparatus 1 is turned on or in a sleep mode, even if no content-related operation is performed.

Described next are several examples of a display on the display unit 10, based on the content-related operation logs described above.

(Example 1 of Display on Display Unit 10)

FIG. 5 shows an example 1 of a display on the display unit 10 based on the content-related operation logs described above. There are icons 20, 21, 22, 23 (two icons 23) and 24 displayed with a same single color on a map, as shown in FIG. 5. The point on the map at which each icon is displayed may be a content-related-operation start or completion point according to a content-related operation log associated with each icon, irrespective of whether there is a movement during a content-related operation. The point on the map at which each icon is displayed may also be a middle point between the content-related-operation start and completion points.

The icons 20 to 24 displayed on the map in FIG. 5 will be explained.

The icon 20 represents emission of an electric wave from a broadcasting station, related to a broadcast content-related operation. Displayed in the icon 20 is a letter R (Record) that indicates recording/video recording. The letter R indicates that the icon 20 is related to a broadcast-content recording log.

The icon 21 represents a CD (Compact Disc) and a music note that is a symbol indicating a song or a musical piece, related to an audio-content reproduction log. The icon 22 represents a microphone, related to an audio-content recording log. The icon 23 represents a movie camera or a video camera, related to a video-content imaging or reproduction log.

The icon 24 represents a still camera, related to a still-image-content imaging log. The icon 24 is displayed when log information of the still-image-content imaging log includes a time and date of imaging and a place of imaging, in addition to a file name of a created file. An imaging direction arrow 24-1 is displayed in a manner that it overlaps the icon 24 or it is displayed around the icon 24 when an imaging direction detected by the sensor unit 15 is recorded as log information of the still-image-content imaging log. With a display of the imaging direction arrow 24-1 on a map displayed on the display unit 10, a user can know which direction from the place of imaging the still-image-content imaging was performed. Moreover, with a display of the imaging direction arrow 24-1, a user can know what was imaged when a name of the place pointed by the arrow 24-1 is also displayed on the map.

In the example 1 of a display in FIG. 5, each of the icons 20 to 24 is displayed at one point on a map on the display unit 10, which is a start point, a completion point or a middle point between the start and completion points, at which a content-related operation was performed. The start, completion and middle points may be switched by a user operation on the operation unit 11. Moreover, the icons 20 to 24 can be displayed in accordance with a moving path, which will be described later.

When a user selects any of the icons 20 to 24 displayed on the map on the display unit 10, through the operation unit 11, content associated with the selected icon and for which a content-related operation has been recorded in a content-related operation log is reproduced. Icon selection is performed in such a way that, when the operation unit 11 is equipped with a touch panel, a user depresses, with a finger or the like, a zone of the touch panel corresponding to an icon the user wants to select.

When a user selects any of the icons 20 to 24 on the map displayed on the display unit 10, content is displayed or reproduced based on a content-related operation log associated with the selected icon, which will be described below for each icon.

When a user selects the icon 20, broadcast content is reproduced that was recorded at a particular point on the map at which the icon 20 is being displayed. In the same way, when a user selects the icon 21, audio content is reproduced that was reproduced once at a particular point on the map at which the icon 21 is being displayed. The particular point on the map at which the icon 20 or 21 is being displayed is the place where the user passed or stayed at with the information display apparatus 1.

When a user selects the icon 22, audio content recorded once is reproduced based on the content-related operation log associated with the icon 22. When a user selects the icon 23, video content is reproduced based on the content-related operation log associated with the icon 23. Video content to be reproduced when the icon 23 is selected is the content that was video-recorded or reproduced once at a particular point indicated by the content-related operation log associated with the icon 23.

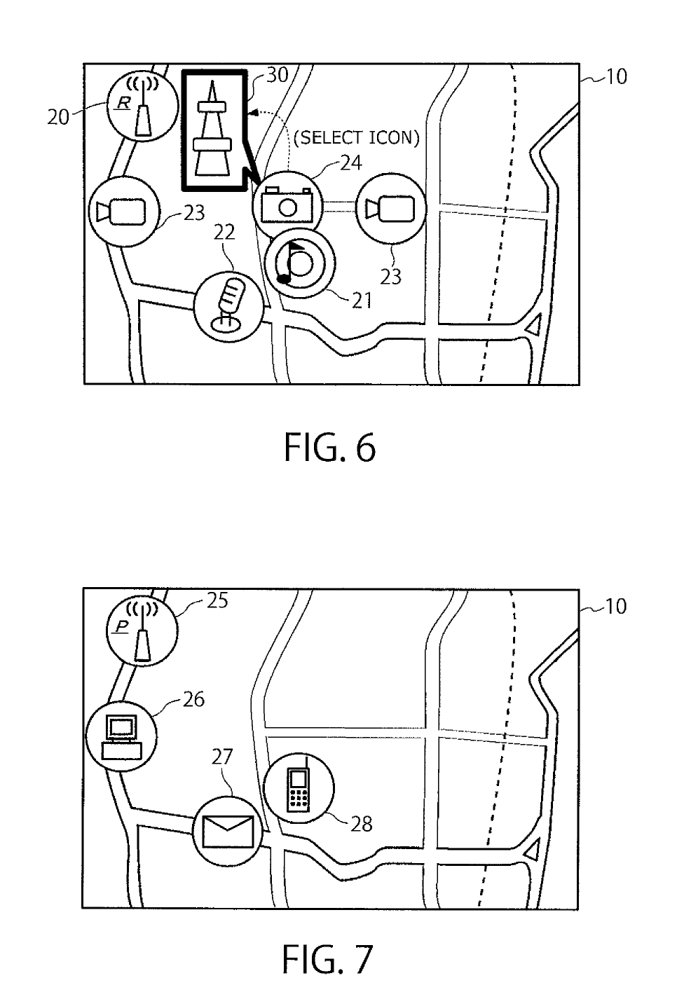

When a user selects the icon 24, still-image content that is content of a still image taken by the imaging unit 18 is reproduced based on the content-related operation log associated with the icon 24. Reproduced and displayed on the display unit 10 in FIG. 6 is a thumbnail image 30 of a photograph that is a still image taken by the imaging unit 18. Detailed information on the photograph, such as a time and date of photographing may also be displayed on the display unit 10. A photograph taken by the imaging unit 18 is displayed on the display unit 10 in a full-screen mode when a user selects the thumbnail image 30 through the operation unit 11.

When the icon 20 related to a broadcast content-related operation is selected in FIG. 5 by a user operation on the operation unit 11, a file of broadcast content is reproduced from the storage unit 12 and broadcast content is played back. When the icon 20 is selected, detailed information on broadcast content may be displayed on the display unit 10, as a content-related operation log. The detailed information may, for example, be a file name (including a TV program title, a broadcasting station name, etc.) of a file to be reproduced, identification information on a broadcasting station, and a time and date of recording. The detailed information may be displayed in a shape of a balloon in the vicinity of the icon 20. A file of broadcast content may be reproduced when the balloon is selected or the icon 20 is selected again. These operations are also applied to the other icons shown in FIG. 5.

When the icon 21 related to an audio-content reproduction log is selected in FIG. 5, a file of audio content is reproduced and played back. Audio content to be played back is, for example, content stored in the storage unit 12, content distributed from an Internet Web site to the information display apparatus 1, and content stored in a CD or DVD when the information display apparatus 1 is equipped with a CD or DVD player. When the icon 21 is selected, detailed information on audio content may be displayed on the display unit 10, as a content-related operation log. The detailed information may, for example, be a file name (a song title, a CD or DVD title, a broadcasting station name, a Web site name, etc.) of a file to be reproduced, a time and date of recording of a file in the storage unit 12.

When the icon 22 related to an audio-content recording log is selected in FIG. 5, reproduced is a file of audio content recorded using a built-in microphone of the audio input unit 19a or an external microphone connected to the audio input unit 19a. When the icon 22 is selected, detailed information on audio content, such as a file name of a created file, a time and date of recording, may be displayed on the display unit 10, as a content-related operation log.

When the icon 23 related to a video-content imaging or reproduction log is selected in FIG. 5, reproduced is video content taken by the imaging unit 18 with its sound input by the audio input unit 19a and recorded in the storage unit 12. When the icon 23 is selected, detailed information on video content, such as a file name of a created file, a time and date of video recording, may be displayed on the display unit 10, as a content-related operation log.

Display of icons for a variety of types of content on a map on the display unit 10, as content-related operation logs, allows a user to select content at a physical location of icons on the map, in addition to time and date. Moreover, display of different types of icons as a variety of content-related operation logs on one screen of the display unit 10 makes easier for a user to know user's actions within a user-set specific period. The map information to be displayed on the display unit 10 may include aerial or satellite photographs.

(Example 2 of Display on Display Unit 10)

FIG. 7 shows an example 2 of a display on the display unit 10 based on the content-related operation logs described above. There are icons 25, 26, 27 and 28 displayed with a same single color on a map, as shown in FIG. 7. Like shown in FIG. 5, in the example 2 of a display in FIG. 7, each of the icons 25 to 28 is displayed at one point on a map on the display unit 10, which is a start point, a completion point or a middle point between the start and completion points, at which a content-related-operation was performed. The start, completion and middle points may be switched by a user operation on the operation unit 11. Moreover, the icons 25 to 28 can be displayed in accordance with a moving path, which will be described later.

The icons 25 to 28 displayed on a map in FIG. 7 will be explained.

The icon 25 represents emission of an electric wave from a broadcasting station, related to a broadcast-content reception log. Displayed in the icon 25 is a letter P (Play) that indicates viewing of and/or listening to broadcast content carried by a broadcast wave from a broadcasting station or received from IP broadcast from a Web site on the Internet.

The icon 26 represents a PC (Personal Computer), related to an application running log. The icon 27 represents an envelop, related to an e-mail transmission/reception log. E-mail transmission and reception logs may be distinguished between each other with a display of letters S (Send) or R (Receive) in the icon 27. The icon 28 represents a mobile phone, related to a communication log (a call log or a call receive log). The call and call receive logs may be distinguished between each other with a display of letters S or R in the icon 28.

A move log with no content-related operations is displayed, for example, with a line that indicates a moving path on a map, without a display of icon.

When the icon 25 related to a broadcast broadcast-content reception log is selected in FIG. 7 by a user operation on the operation unit 11, the information display apparatus 1 receives real-time broadcast from a broadcasting station recorded in the broadcast broadcast-content reception log. When the icon 25 is selected, detailed information on broadcast content may be displayed on the display unit 10, as a content-related operation log, before broadcast is received. The detailed information may, for example, be past time and date of viewing of and/or listening to the broadcast and a frequency (channel), or URL. The detailed information may be displayed in a shape of a balloon in the vicinity of the icon 25. Broadcast may be received when the balloon is selected or the icon 25 is selected again. These operations are also applied to the other icons shown in FIG. 7.

When the icon 26 related to an application running log is selected in FIG. 7 by a user operation on the operation unit 11, the information display apparatus 1 runs an application recorded in the application-content running log. A file can be executed, if there is in the storage unit 12, for example, and that was once executed by running the application. When the icon 26 is selected, detailed information on application content, such as prior operations (from start to end), an application title, and a file name of a file executed by running the application may be displayed on the display unit 10, as an application running log.

When the icon 27 related to an e-mail transmission/reception log is selected in FIG. 7, the information display apparatus 1 displays the content of transmitted or received e-mails recorded in the log on the display unit 10. Moreover, when the icon 27 is selected, detailed information on e-mail content, such as times and dates of prior e-mail transmission/reception, e-mail addresses, and mail recipient names may also be displayed on the display unit 10, as an e-mail transmission/reception log.

When the icon 28 related to a communication log is selected in FIG. 7, the information display apparatus 1 displays a phone number recorded in the log on the display unit 10 and is put into a standby mode for calling to the displayed number. Moreover, when the icon 28 is selected, detailed information on communication, such as times and dates of prior calling and call reception, and names of callers/receivers may also be displayed on the display unit 10, as a communication log.

(Example 3 of Display on Display Unit 10)

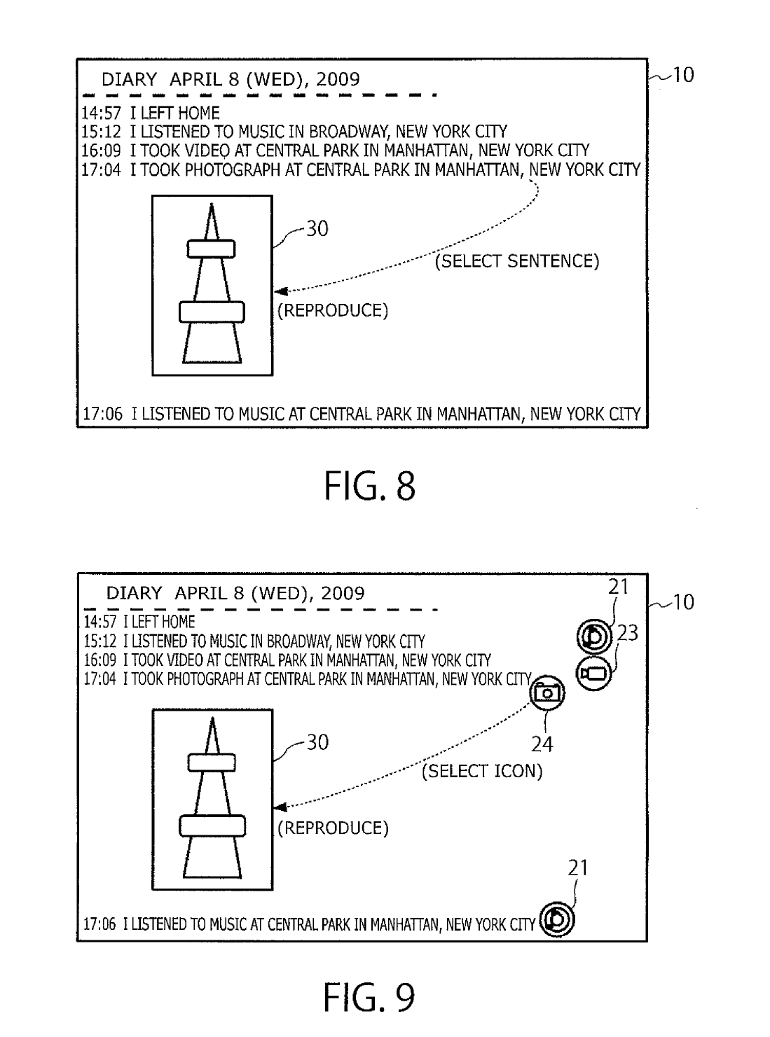

FIG. 8 shows an example 3 of a display on the display unit 10 based on the content-related operation logs described above. A display of the example 3 appears on the display unit 10 when a user selects any icon shown in FIG. 5, for example. In the example 3, the information display apparatus 1 displays a plurality of sentences (text information) on the display unit 10, concerning actions performed by a user at specific times a day in chronological order, like a diary. When a user selects any sentence through the operation unit 10, the information display apparatus 1 executes a content-related operation that corresponds to the selected sentence.

In the example 3, as shown in FIG. 8, a title “Diary April 8 (Wed), 2009” is displayed on the uppermost screen area of the display unit 10, for a diary-type content-related operation log. This diary type log is displayed, for example, when a user enters a specific time and date on the operation unit 10 or a user selects a specific time and date from times and dates on a calendar displayed on the display unit 10.

The following description concerning the actions with respect to FIG. 8 and also FIGS. 9 to 12 is based on an example of user's content-related operations on April 8 (Wed), 2009 performed after a user left home at 14:57. The user's content-related operations are such that a user listened to music in Broadway, New York City at 15:12, took videos at Central Park in Manhattan, New York City at 16:09, took photographs at Central Park in Manhattan, New York City at 17:04, and listened to music at Central Park in Manhattan, New York City at 17:06. These user's content-related operations are recorded in the content-related operation logs as described with respect to the flowchart of FIG. 2.

The controller 16 acquires current-position information on the current position of the information display apparatus 1 from the position-information acquisition unit 13 at specific intervals and detects whether the current position is different from position coordinates (such as latitude and longitude) registered for the location of a user's home. If it is detected that the current position is different from the registered position coordinates (which means that the information display apparatus 1 is not located at a user's home), the controller 16 creates a sentence “I left home.” and attaches it to the time 14:57. The current time is obtained by a clock (not shown) built in the controller 16, as already described.

The time to which the sentence “I left home.” is attached may be determined when either one of the following requirements is met.

A first requirement is that it is detected that the current position obtained by the position-information acquisition unit 13 is different from the registered position coordinates (registered as a user's home) and the distance from the registered position coordinates to the current position is a specific distance or more. In the first requirement, the time at which it is detected first that the current position is different from the registered position coordinates is determined as the time to which the sentence “I left home.” is attached. The first requirement is based on an assumption that a user has left home with the information display apparatus 1 when the distance from the registered position coordinates to the current position is a specific distance or more.

A second requirement is that it is detected that the current position obtained by the position-information acquisition unit 13 is different from the registered position coordinates (registered as a user's home) and the time has passed beyond a predetermined time since the detection of positional difference. Also, in the second requirement, the time at which it is detected first that the current position is different from the registered position coordinates is determined as the time to which the sentence “I left home.” is attached. The second requirement is based on an assumption that a user has left home with the information display apparatus 1 when the time has passed beyond a predetermined time since the detection of positional difference.

The controller 16 acquires the current-position information from the position-information acquisition unit 13 at specific intervals and also acquires content-related operation information as described with respect to the flowchart of FIG. 2.

With the acquired current-position information and content-related operation information, the controller 16 creates a sentence “I listened to music in Broadway, New York City.” and attaches it to the time 15:12 that is the time at which a user reproduced audio data, based on the audio-content reproduction log, as shown in FIG. 8. The sentence pattern “I listened to music” is created for, for example, reproduced audio data that has been stored in a Music folder or the like in the storage unit 12. A sentence pattern “I listened to a sound” may be created for reproduced audio data that has been stored in a Data folder or the like in the storage unit 12. Moreover, the same sentence pattern may be created for any reproduced audio data irrespective of the type of audio data.

In the same way, the controller 16 creates a sentence “I took video at Central Park in Manhattan, New York City.” and attaches it to the time 16:09 that is the time at which a user took videos, based on the video-content reproduction log, as shown in FIG. 8. In creation of the sentence at this stage, the name of place or facility for which the latitude and longitude have been recorded in the video-content reproduction log is created by looking up to map data.

In the same way, the controller 16 creates a sentence “I took photograph at Central Park in Manhattan, New York City.” and attaches it to the time 17:04 that is the time at which a user took photographs, based on the still-image-content reproduction log, as shown in FIG. 8. In the example 3 of FIG. 8, a thumbnail image 30 of a photograph taken by a user is popped up under the sentence attached to the time 17:04 and between this sentence and the other sentence attached to the time 17:06 when the user selects the sentence “I took photograph at Central Park in Manhattan, New York City.”. Not only between the sentences, the thumbnail image 30 may be popped up as overlapping the sentence “I took photograph at Central Park in Manhattan, New York City.”.

In the same way, the controller 16 creates a sentence “I listened to music at Central Park in Manhattan, New York City.” and attaches it to the time 17:06 that is the time at which a user reproduced audio data, based on the audio-content reproduction log, as shown in FIG. 8.

As described above, in the example 3 of FIG. 8, the thumbnail image 30 of a photograph is popped up when a user selects the sentence “I took photograph at Central Park in Manhattan, New York City.”. In the same way, audio data can be reproduced when a user selects the sentence “I listened to music in Broadway, New York City.” or “I listened to music at Central Park in Manhattan, New York City.”. Also, in the same way, video data can be reproduced when a user selects the sentence “I took video at Central Park in Manhattan, New York City.”. In this way, content can be selected from a diary-type content-related operation log displayed on the display unit 10, while confirming several user actions or operations on the log. Moreover, the diary-type content-related operation log in the example 3 of FIG. 8 is a combination of several content-related operation logs, such as the audio-, video-, and still-image-content reproduction logs, displayed on one screen in accordance with the progression of time. Therefore, a user can easily confirm several actions or operations on a given day in accordance with the progression of time on one screen.

(Example 4 of Display on Display Unit 10)

FIG. 9 shows an example 4 of a display on the display unit 10 based on the content-related operation logs described above. A display of the example 4 appears on the display unit 10 when a user selects any icon shown in FIG. 5, for example. In addition to a diary-type content-related operation log like the example 3 of FIG. 8, FIG. 9 shows icons 21 (two icons 21), 23 and 24 (like those shown in FIGS. 5 and 6) attached to the corresponding sentences and displayed at the end of each sentence. In the example 4 of FIG. 9, a thumbnail image 30 of a photograph taken by a user is popped up like shown in FIG. 8 when the user selects the icon 24 attached to the sentence “I took photograph at Central Park in Manhattan, New York City.”.

Described more in detail with respect to FIGS. 8 and 9, are operations on the display unit 10, other than those performed when the sentence “I took photograph at Central Park in Manhattan, New York City.” is selected (the example 3) or the icon 24 attached to this sentence is selected (the example 4), as described above.

When a user selects the sentence “I listened to music in Broadway, New York City.” (FIG. 8) or the icon 21 attached to this sentence (FIG. 9) based on the audio-content reproduction log, an image (not shown) related to the audio data corresponding to the selected sentence or icon is displayed on the display unit 10. An image related to the audio data is, for example, a photograph of an album jacket. If there is no such a related image, information (not shown) related to the audio data, such as a file name of the audio data is displayed on the display unit 10. Reproduction of audio data may start when such an image or information related to the audio data is displayed or when a user selects the corresponding sentence or icon again or the displayed image or information related to the audio data.

In the same way, a thumbnail video (not shown) of video data taken by a user is popped up when a user selects the sentence “I took video at Central Park in Manhattan, New York City.” (FIG. 8) or the icon 23 attached to this sentence (FIG. 9) based on the video-content reproduction log.

(Example 5 of Display on Display Unit 10)

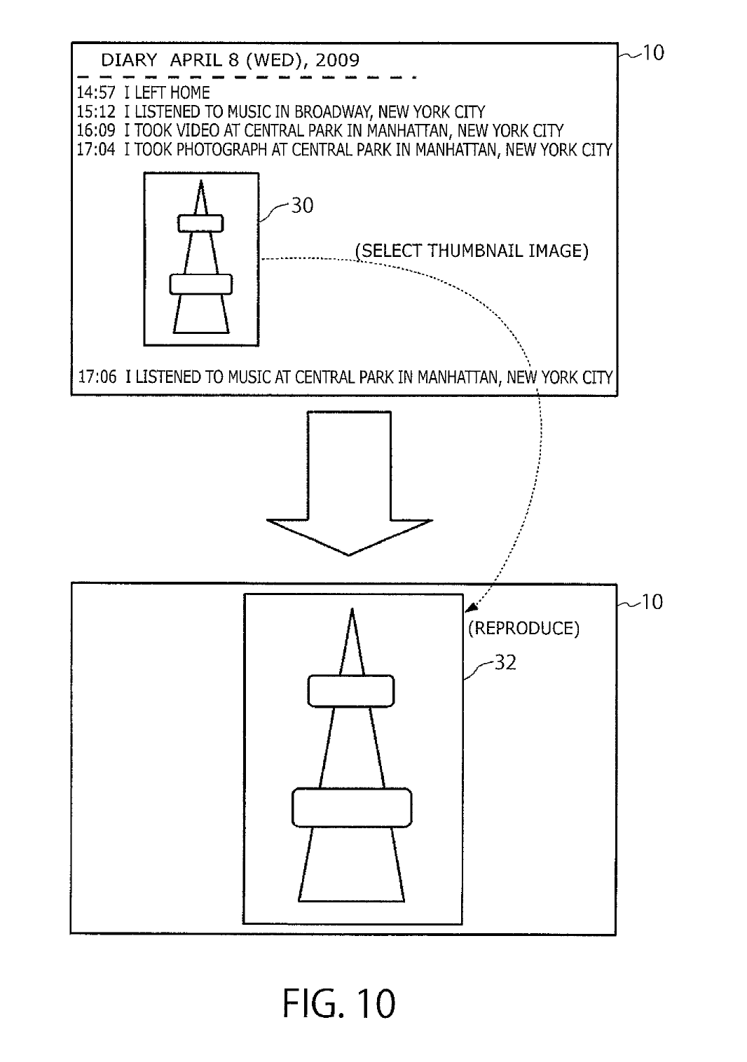

FIG. 10 shows an example 5 of a display on the display unit 10 based on the content-related operation logs described above. A display of the example 5 appears on the display unit 10 when a user selects any icon shown in FIG. 5, for example. Like the example 3 of FIG. 8, FIG. 10 shows a diary-type content-related operation log and a thumbnail image 30 of a photograph taken by a user that is popped up when a user selects the sentence “I took photograph at Central Park in Manhattan, New York City.”. Moreover, in the example 5 of FIG. 10, when a user selects the thumbnail image 30 like an icon, an original photograph 32 taken by the user is popped up instead of the image 30 on the same screen. In detail, the original photograph 32 is displayed at a given scale larger than the image 30, for example, in a full-screen mode, as shown in a lower figure of FIG. 10. This type of user operation for displaying a large original photograph can also be performed in the examples 3 and 4 of FIGS. 8 and 9, respectively. Moreover, this type of user operation can also be performed for thumbnail videos based on the broadcast-content recording log, the video-content reproduction log, and the video-content imaging log. In this user operation, when a user selects a thumbnail video, an original video based on a log related to the selected thumbnail video is displayed on the display unit 10 in a full-screen mode. Display of an original photograph or video in a full-screen mode can also be done when a user selects the corresponding sentence or icon while a thumbnail photograph or video is displayed.

(Example 6 of Display on Display Unit 10)

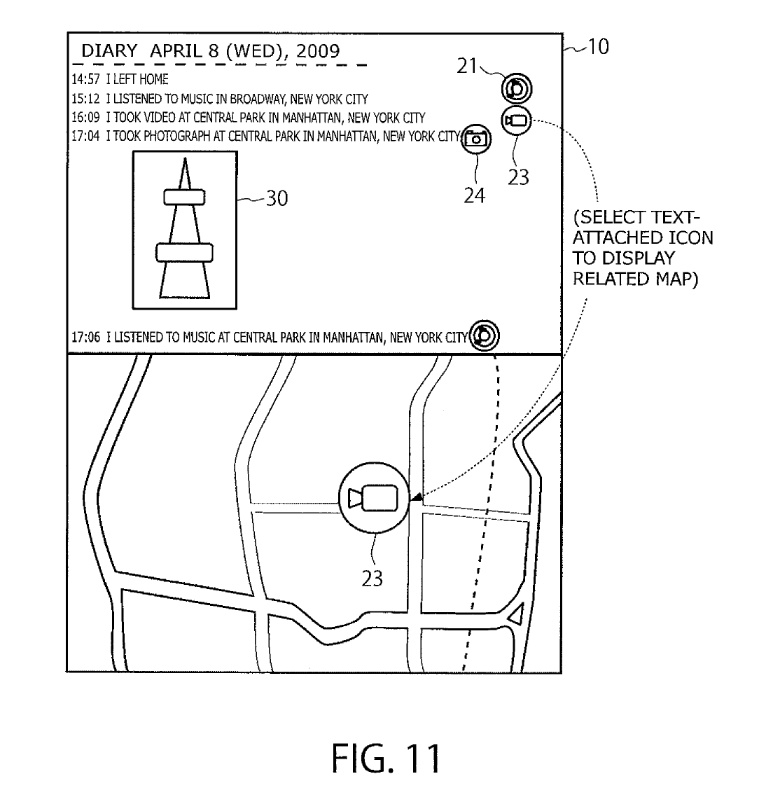

FIG. 11 shows an example 6 of a display on the display unit 10 based on the content-related operation logs described above. The upper part (a diary-type content-related operation log) of a display of the example 6 appears on the display unit 10 when a user selects any icon shown in FIG. 5, for example. The example 6 is a combination of the examples 3 and 4 of FIGS. 8 and 9, respectively. In the example 6 of FIG. 11, a thumbnail image 30 of a photograph taken by a user is popped up like shown in FIG. 8 when the user selects the sentence “I took photograph at Central Park in Manhattan, New York City.” or the icon 24 attached to this sentence. Moreover, in the example 6 of FIG. 11, when a user selects a sentence or an icon attached to this sentence, a map corresponding to a content-related operation log related to this sentence is displayed on the display unit 10. When a map is displayed, a selected icon or an icon for which the corresponding sentence has been selected is also displayed on the display unit 10.

Shown in FIG. 11 is that when a user selects the icon 23 attached to the sentence “I took video at Central Park in Manhattan, New York City.” (or selects this sentence), a map corresponding to a video-content imaging log related to this sentence is displayed on the display unit 10. A map is not displayed until a sentence or an icon attached this sentence is selected. In the example 6 of FIG. 10, the screen of the display unit 10 is divided into two windows for displaying sentences and a map, respectively. Nevertheless, the screen may be of one window like shown in FIG. 9 only for sentences until a sentence or an icon is selected. Moreover, icons may not be displayed like shown in FIG. 8 with a display of sentences only.

A map in the example 6 may be displayed on a scale of, for example, 1/5000 in order for an exact location to be identified with a selected icon (or an icon for which the corresponding sentence has been selected) being displayed at the center of the map. Moreover, a map in the example 6 may be displayed on a scale large enough so that all of the icons included in a specific period can be displayed. The specific period in this case coves all log information for, for example, a day, that include a selected icon or sentence. Furthermore, when a sentence or an icon attached to this sentence is selected, an icon related to log information corresponding to the selected sentence or icon may only be displayed on a map. Or when a sentence or an icon attached to this sentence is selected, all of the icons included in a specific period that covers all log information for, for example, a day may be displayed on a map. The specific period is specified based on the time information acquired by a clock (not shown) built in the controller 16.

In the example 6 of FIG. 11, a diary-type content-related operation log is displayed on the upper window while a map is displayed on the lower window of the display unit 10. Not only that, a diary-type content-related operation log may be displayed on the lower window while a map is displayed on the upper window. Moreover, not only the vertical dual windows shown in FIG. 11, horizontal dual windows may be displayed if the screen is wide horizontally. The ratio of the upper (or left) to lower (or right) windows on window size may be adjusted by a user operation on the operation unit 11.

(Example 7 of Display on Display Unit 10)

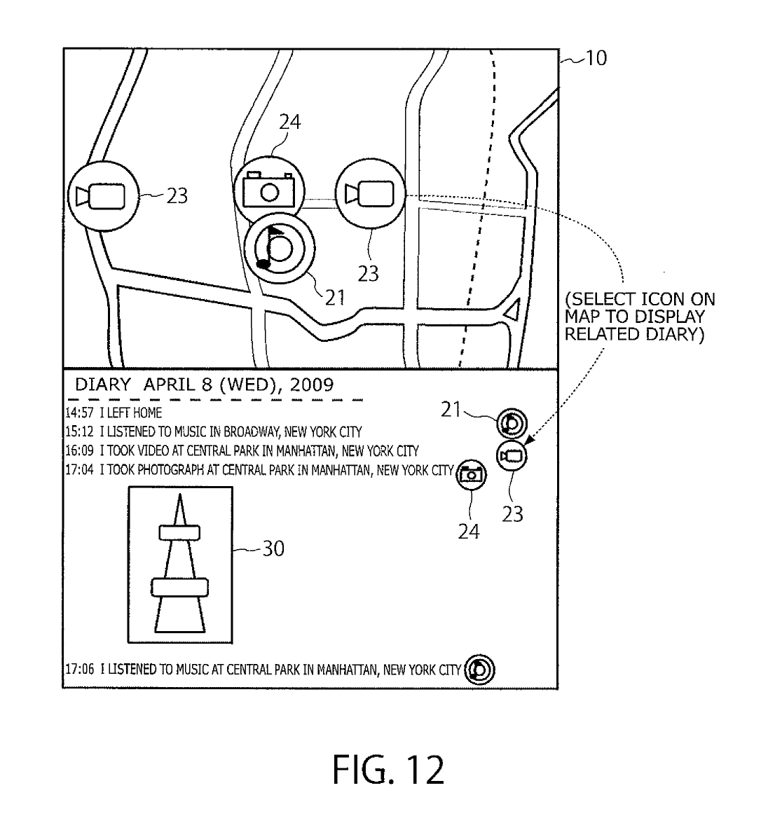

FIG. 12 shows an example 7 of a display on the display unit 10 based on the content-related operation logs described above. In FIG. 12, there are icons 21, 23 (two icons 23) and 24 displayed on a map, like those shown in FIG. 5. In the example 7, when an icon is selected on a map, a sentence corresponding to the selected icon is displayed on the display unit 10, based on a particular content-related operation log related to the selected icon. In addition to the sentence corresponding to the selected icon, what can be displayed are other sentences related to the particular content-related operation log and corresponding to the operations performed before and after the operation corresponding to the sentence for which the icon has been selected. Or the entire one-day content-related operation log including the sentence corresponding to the selected icon may be displayed.

Shown in FIG. 12 is that the icon 23 displayed on the right side of the icon 24 is selected on a map in the upper window so that a diary-type content-related operation log (like the example 4 of FIG. 9) is displayed on the lower window. In the example 7 of FIG. 12, the screen of the display unit 10 is divided into two windows for displaying a map and a diary-type content-related operation log, respectively. However, no sentence or a log is displayed until an icon is selected on a map, in this example. Therefore, the screen may be of a one window like shown in FIG. 5 only for displaying a map until an icon is selected on a map.

Time may be displayed only for a particular sentence for which an icon has been selected or for the particular sentence and also the sentences displayed above and under the particular sentence. Also shown in FIG. 12 is a thumbnail image 30 popped up like shown in FIGS. 8 and 9 when a user selects an icon or a sentence of a diary-type content-related operation log in the lower window. Icons of a diary-type content-related operation log may not be displayed, like shown in FIG. 8.

In the example 7 of FIG. 12, a map is displayed on the upper window while a diary-type content-related operation log is displayed on the lower window of the display unit 10. Not only that, a map may be displayed on the lower window while a diary-type content-related operation log may be displayed on the upper window. Moreover, not only the vertical dual windows shown in FIG. 12, horizontal dual windows may be displayed if the screen is wide horizontally. The ratio of the upper (or left) to lower (or right) windows on window size may be adjusted by a user operation on the operation unit 11.

(Example 8 of Display on Display Unit 10)

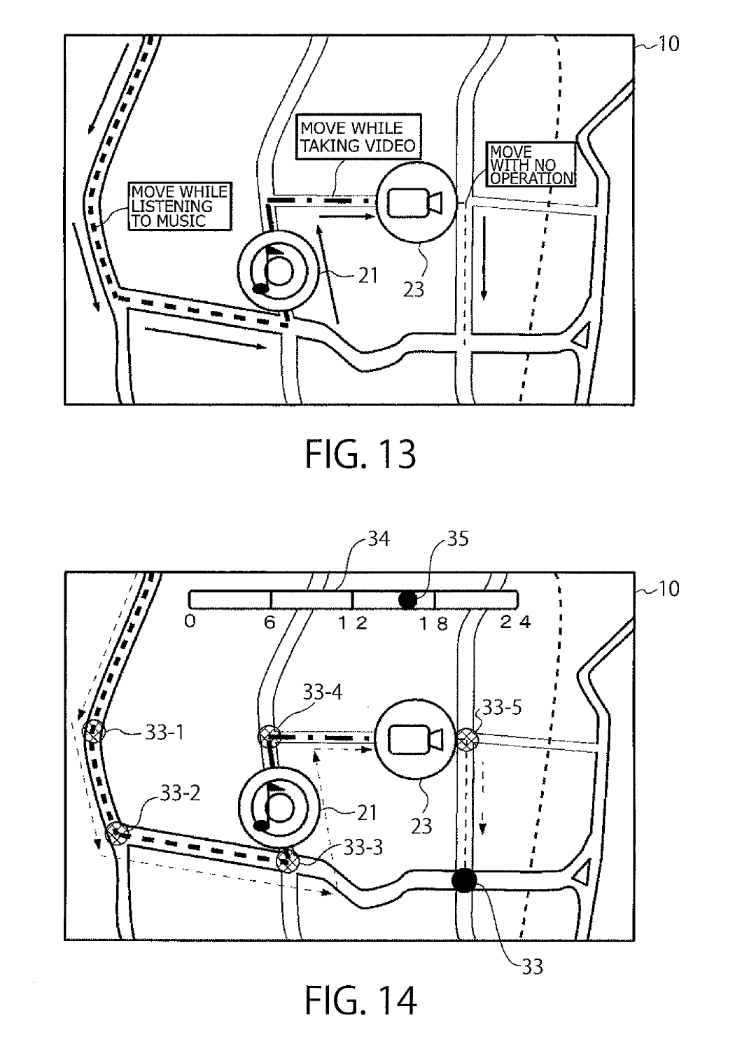

FIG. 13 shows an example 8 of a display on the display unit 10 based on the content-related operation logs and the move log described above. In the examples 1 and 2 of FIGS. 5 and 6, respectively, each of the icons 20 to 24 is displayed on one point on a map, such as a content-related-operation start point, a content-related-operation completion point and a middle point between the start and completion points. On the other hand, in the example 8 of FIG. 13, a route of movement of a user who moved with the information display apparatus 1 is displayed together with an icon related to a content-related operation log.

In a display of the example 8, there are several arrow signs that indicate, as follows. Solid-line arrows indicate a direction in which a user moved. A thick broken line with an icon 21 indicates a route of movement of the user who moved while reproducing audio content. A thick dashed doted line with an icon 23 indicates a route of movement of the user who moved while reproducing or recording video content. A thin broken line indicates a route of movement of the user who moved while performing no content-related operation with the information display apparatus 1. The solid-line arrows, the thick broken line, the thick dashed doted line, and the thin broken line are displayed with a same single color, the same being also applied to examples 9 and 10 which will be described later.

In the example 8 of FIG. 13, the icons 21 and 23 are displayed at a content-related operation completion point. However, each icon may be displayed on any of the content-related-operation start point, the content-related-operation completion point and a middle point between the start and completion points, which can be switched by a user operation on the operation unit 11.

Moreover, in the example 8 of FIG. 13, a diary-type content-related operation log, such as shown in FIGS. 8 to 11 is displayed on the display unit 10 when a user selects the icon 21 or 23. Once a diary-type content-related operation log is displayed, the several operations described with respect to FIGS. 8 to 11 can also be performed in the example 8 of FIG. 13, the same being applied to the following examples 9 and 10. In addition, the several operations described with respect to FIG. 12 can also be performed in the example 8 of FIG. 13, the same being applied to the following examples 9 and 10.

(Example 9 of Display on Display Unit 10)

FIG. 14 shows an example 9 of a display on the display unit 10 based on the content-related operation logs and the move log described above. Displayed in the example 9 of FIG. 14, is a route log of a route of movement of a user who moved and of content-related operations the user performed while the user was moving. In detail, in the example 9 of FIG. 14, a black circle object 33 moves at a specific travel speed to indicate a route of movement of a user who moved and content-related operations the user performed while the user was moving. Hatched circle signs 33-1, 33-2, 33-3, 33-4 and 33-5 indicate specific points at which the black circle object 33 has passed. The travel speed of the black circle object 33 may be changed by a user operation on the operation unit 11. With a display of the example 9 in FIG. 14, a user can confirm which route the user took and what content-related operations the user performed while moving, in a short time period, by viewing a moving black circle object 33. Moreover, although not shown, whenever the black circle object 33 passes the icons 21 and 23, detailed information on the content related to these icons may be displayed.

Although it is an option, displayed on the upper part of the screen in the example 9 of FIG. 14 is a time bar 34 with a black circle object 35 that moves in synchronism with the black circle object 33. The location of the time bar 34 to be displayed on the screen can be changed by a user operation on the operation unit 11. The time scale indicated by the time bar 34 may be a day, a week, etc., depending on a route log to be displayed. The time bar 34 shown in FIG. 14 indicates a one-day time scale from 0 to 24 hours in which the black circle object 35 is moving from a particular time to another between 0 to 24 hours in accordance with a route log.

(Example 10 of Display on Display Unit 10)

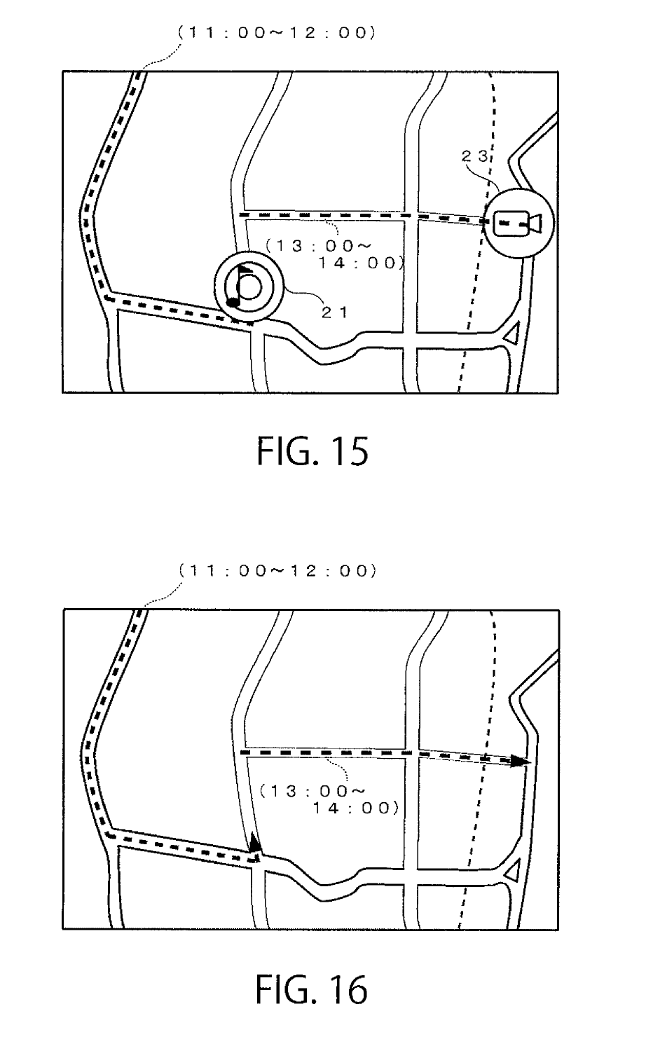

FIG. 15 shows an example 10 of a display on the display unit 10 based on the content-related operation logs described above. Displayed in the example 10 of FIG. 15 is a route log of a user who moved with the information display apparatus 1 for a specific time period. In the example 10 of FIG. 15, there are two user's routes indicated with thick broken lines. A first route is from the time 11:00 to 12:00 during which a user was moving with the information display apparatus 1. An icon 21 is displayed at the end of the first route, that indicates a user's movement while reproducing a CD or DVD. A second route is from the time 13:00 to 14:00 during which a user was moving with the information display apparatus 1. An icon 23 is displayed at the end of the second route, that indicates a user's movement while recording videos. In addition to the time, the date and year may also be displayed.

(Example 11 of Display on Display Unit 10)

FIG. 16 shows an example 10 of a display on the display unit 10 based on the content-related operation logs described above. Displayed in the example 11 of FIG. 16 is a route log of a user who moved with the information display apparatus 1 for a specific time period, with no display of icons. In the example 11 of FIG. 16, there are two user's routes indicated with thick broken lines. A first route is from the time 11:00 to 12:00 during which a user was moving with the information display apparatus 1. A second route is from the time 13:00 to 14:00 during which a user was moving with the information display apparatus 1. In addition to the time, the date and year may also be displayed.

(Program for Information Display Control)

Several functions, such as those described with respect to the display examples 1 to 11, of the information display apparatus 1 and the several units thereof shown in FIG. 1 can be achieved with a general-purpose information processing apparatus (or a computer) that works while software programs are running thereon. Such a general-purpose information processing apparatus is equipped, for example, with a CPU, memories and input/output ports, etc. The CPU retrieves a control program from a memory or the like and runs the control program to achieve the functions of the several units of the information display apparatus 1 shown in FIG. 1. Other necessary functions can also be achieved with software programs that run on the general-purpose information processing apparatus. The CPU may be replaced with an ASIC, a microprocessor (microcomputer), a DSP, etc.

The control program described above may be stored in a memory of a general-purpose information processing apparatus, before or after shipped. Part of the control program may be installed in a memory of a general-purpose information processing apparatus, after shipped, from a computer-readable storage medium such as a CD-ROM or downloaded over the Internet or the like.

The control program described above is not only a control program stored in a memory of a general-purpose information processing apparatus so that the information processing apparatus can retrieve the program from its own memory. The control program may be installed in a hard disk and retrieved by a general-purpose information processing apparatus. Moreover, the control program may be compressed or encoded.

Achieving several functions and several units of the information display apparatus 1 by means of a general-purpose information processing apparatus and software programs running thereon allows mass-production and design or specification modifications.

It is further understood by those skilled in the art that the foregoing description is a preferred embodiment of the disclosed apparatus, method or program and that various changes and modifications may be made in the invention without departing from the sprit and scope thereof.

For example, content-related operations and user's routes are displayed on the display unit 10 of the information display apparatus 1 with icons and several types of arrows and lines, respectively, with a same single color. However, the icons and routes may be displayed with different colors depending on content-related operations. Moreover, the icons may be displayed in the form of a moving picture or by means of animation. Furthermore, the icons may be created by a user or downloaded over the Internet or the like.

There are two types of display on the display unit 10 of the information display apparatus 1 in the embodiment. One type is a horizontally wide display such as shown in FIGS. 5 to 10 and 13 to 16. The other type is a vertically wide display such as shown in FIGS. 11 and 12. These two types of display may be switched depending on the attitude of the information display apparatus 1 detected by an acceleration sensor of the sensor unit 15.

In the embodiment, an icon is displayed at the end of a sentence, such as shown in FIG. 9. Not only that, an icon may be displayed at the head of or in the middle of a sentence. For example, the icon 23 may be displayed just before or after the word “video” of the sentence “I took video at Central Park in Manhattan, New York City.”.

In the several display examples, some of the displays appeared on the display unit 10 of the information display apparatus 1 are a diary-type action log that is the record of what actions or operations were performed and where the actions or operations were performed, in chronological order. Not only in chronological order, the record may be displayed based on the coordinates. For example, the record may be displayed in a direction from north to south on a map.

As described above, an acceleration sensor and a gyro sensor may be installed in the sensor unit 15 for complementing position information on the current position of the information display apparatus 1 acquired by the position-information acquisition unit 13, for higher accuracy. With such sensors, the current position of the information display apparatus 1 can be assumed in a place, such as a tunnel, an underground shopping center, etc., where it is hard for the position-information acquisition unit 13 to acquire the position information.

The content-related operation logs to be recorded by the controller 16 of the information display apparatus 1 may not necessarily be limited to those described above. Some other content-related operation logs that can be recorded by the controller 16 are, for example, a game log for performing games, a dictionary log for looking up words in dictionaries, a Web browse log, a blog log for blogging and/or blog browsing, and a Twitter log for Twitter blogging and/or browsing.

It is preferable for the content-related operation logs to take privacy protection measures, for example, password entry through the operation unit 11 before browsing the operation logs.

For simultaneous content-related operations, for example, taking a photograph while listening to music, icons corresponding to the operations simultaneously performed are displayed on the display unit 10 of the information display apparatus 1. In this case, it is preferable that the icons are overlapped each other when displayed, the icons are alternately displayed, or comparatively small icons are aligned when displayed. Display of icons may be limited to specific content-related operations. There is a case in which several icons have to be displayed on a small area of a map, the area being smaller than the size of one icon. In this case, the icons may be overlapped each other on the small area with a specific distance between the centers of these icons. Or one icon may be completely covered with another icon. In either case, an icon for the latest content-related operation is displayed on the top of the overlapped icons.

Moreover, it is preferable for the information display apparatus 1 to be equipped with a switching function in displaying a map on the display unit 10, concerning the scale of a map, display of address on a map, etc. according to the necessity.

### Advantage of Embodiment

The embodiment of the present invention described above has several advantages.

As described above, the information display apparatus 1 records content-related operation logs in the storage unit 12, with time information and position (coordinates) information. When the content-related operation logs are stored, icons that indicate the type of content are assigned to the respective operation logs. When a map is displayed on the display unit 10, the icons assigned to the respective operation logs are also displayed thereon based on the position information. Then, when an icon-related operation (such as selection of an icon) is performed, a content-related operation, such as reproduction of a photograph, is performed.

With these functions, icons that represent several types of content-related operation logs can be simultaneously displayed on the display unit 10 of the information display apparatus 1. When icons are simultaneously displayed on a map on the display unit 10, such as shown in FIG. 5, the type and the contents of each piece of content for which a content-related operation was performed at a particular location on the map can be easily identified. Moreover, by selecting an icon, a user can perform a content-related operation corresponding to the selected icon, such as reproduction of video, while referring to a content-related operation log. The content-related operation log to be referred here is the selected icon itself that represents a content-related operation such as shown in FIG. 5 or a content-related operation log such as shown in FIG. 9, for example. Therefore, a user can easily confirm the contents of each piece of content for which the user performed a content-related operation in the past, such as video recording. Then, user can perform again the content-related operation performed in the past or reproduce the content created by a content-related operation performed in the past.

Moreover, as described in the example 6, the icons corresponding to content-related operation logs in a specific period specified based on time information may only be displayed on a map on the display unit 10 under control by the controller 16. The selection of icons to be displayed eliminates display of icons not necessary in the specific period, thus simplifying the contents of a display on the display unit 10.

Moreover, as described in the examples 8 to 11, when a content-related operation was performed with movement, an icon corresponding to the operation and a route of movement while operation was performed can be displayed on the display unit 10 under control by the controller 16. With a display of such icons and routes, a user can confirm content-related operation logs together with move logs. Therefore, a user can recall, in chronological order, the contents of each piece of content for which a content-related operation was performed or a user can perform again the content-related operation once performed.

Moreover, as described in the examples 3 to 7, a content-related operation log is displayed on the display unit 10 with times and corresponding sentences, as a diary-type content-related operation log. When a specific operation is performed to a sentence (for example, selection of a sentence or an icon corresponding to the sentence), a content-related operation corresponding to the sentence is performed (for example, the content corresponding to the sentence, such as a video or photograph is displayed.).

With a display of a diary-type content-related operation log, a user can confirm content-related operations performed in the past by referring to the sentences in the operation log. In addition, in the examples 6 and 7 of FIGS. 11 and 12, respectively, a user can visually confirm content-related operations performed in the past by referring to icons on a map.

Moreover, an icon displayed at the end of a sentence, such as shown in FIG. 9, may be displayed at the head of or in the middle of a sentence. With a display of an icon at the head, in the middle or at the end of a sentence, a user can view both of a sentence and an icon together which enable the user to certainly confirm content-related operations performed in the past, in different ways.

Furthermore, as described in the example 6, when a specific operation is performed to a sentence (for example, selection of a sentence or an icon corresponding to the sentence), information related to the content corresponding to the sentence is displayed on a map, as an icon. Conversely, as described in the example of 7, when an icon is selected on a map, information related to the content corresponding to the icon is displayed on a map, as a sentence. With a display of information as an icon or a sentence, a user can view both of a diary-type content-related operation log and a map together which enable the user to certainly confirm content-related operations performed in the past, in different ways.

As described above in detail, the present invention provides an information display apparatus, and a method and a program for information display control, enabling simultaneous display of records of operations related to a variety of types of content on a map.

What is claimed is:

1. An information display apparatus comprising:
an operation section configured to perform a content-related operation related to each of a plurality of types of content;
a content-related operation log acquisition section configured to acquire a content-related operation log as associated with each content for which the content-related operation is being performed by the operation section and also as associated with a type of the each content, the content-related operation log including a move log having position information on a position of the information display apparatus and time information on time during performance of the content-related operation related to the each content;
a display section configured to display map information based on the position information and to display at least an icon on the displayed map information based on the content-related operation log, the icon representing the type of the each content; and
a controller configured to control the operation section to perform the content-related operation related to the each content when an instruction is given to the displayed icon.

2. The information display apparatus according to claim 1, wherein the time information indicates a specific period of time and the icon represents a type of content for which a content-related operation is performed within the specific period of time.

3. The information display apparatus according to claim 1, wherein the position information indicates a specific area on the map information and the icon represents a type of content for which a content-related operation is performed within the specific area.

4. The information display apparatus according to claim 1, wherein the controller controls the display section to display the content-related operation log when an instruction is given to the icon, the displayed content-related operation log including the time information and text information that indicates the content-related operation related to the each content, the time and text information being displayed in chronological order, wherein the controller controls the operation section to perform the content-related operation when an instruction is given to the displayed text information.

5. The information display apparatus according to claim 4, wherein an icon that represents a type of content is displayed by the display section so as to correspond to the text information when the content-related operation log is displayed.

6. The information display apparatus according to claim 5, wherein the controller controls the display section to display map information based on position information included in a content-related operation log for content associated with the text information or the icon displayed by the display section when an instruction is given to the displayed text information or icon.

7. The information display apparatus according to claim 1, wherein the controller controls the display section to display text information that indicates the content-related operation related to the each content when an instruction is given to the icon.

8. The information display apparatus according to claim 1, wherein the display section displays a route on the displayed map information based on the content-related operation log, the route indicating movement of the information display apparatus during the performance of the content-related operation related to the each content.

9. A method for information display control comprising the steps of:
performing a content-related operation related to each of a plurality of types of content;
acquiring a content-related operation log as associated with each content for which the content-related operation is being performed and also as associated with a type of the each content, the content-related operation log including a move log having position information on a position related to performance of the content-related operation related to each content and time information on time during the performance of the content-related operation related to the each content;
displaying map information based on the position information and displaying at least an icon on the displayed map information based on the content-related operation log, the icon representing the type of the each content; and
initiating the performance of the content-related operation related to the each content when an instruction is given to the displayed icon.

10. The method according to claim 9, wherein the time information indicates a specific period of time and the icon represents a type of content for which a content-related operation is performed within the specific period of time.

11. The method according to claim 9, wherein the position information indicates a specific area on the map information and the icon represents a type of content for which a content-related operation is performed within the specific area.

12. The method according to claim 9, further comprising the steps of:
displaying the content-related operation log when an instruction is given to the icon, the displayed content-related operation log including the time information and text information that indicates the content-related operation related to the each content, the time and text information being displayed in chronological order; and
initiating the performance of the content-related operation when an instruction is given to the displayed text information.

13. The method according to claim 12, further comprising the step of displaying an icon that represents a type of content section so as to correspond to the text information when the content-related operation log is displayed.

14. The method according to claim 13, further comprising the step of displaying map information based on position information included in a content-related operation log for content associated with the displayed text information or icon when an instruction is given to the displayed text information or icon.

15. A program for information display control stored in a non-transitory computer readable storage medium, the program comprising:
a program code of performing a content-related operation related to each of a plurality of types of content;
a program code of acquiring a content-related operation log as associated with each content for which the content-related operation is being performed and also as associated with a type of the each content, the content-related operation log including a move log having position information on a position related to performance of the content-related operation related to each content and time information on time during the performance of the content-related operation related to the each content;
a program code of displaying map information based on the position information and displaying at least an icon on the displayed map information based on the content-related operation log, the icon representing the type of the each content; and
a program code of initiating the performance of the content-related operation related to the each content when an instruction is given to the displayed icon.

16. The program according to claim 15, wherein the time information indicates a specific period of time and the icon represents a type of content for which a content-related operation is performed within the specific period of time.

17. The program according to claim 15, wherein the position information indicates a specific area on the map information and the icon represents a type of content for which a content-related operation is performed within the specific area.

18. The program according to claim 15, further comprising:
a program code of displaying the content-related operation log when an instruction is given to the icon, the displayed content-related operation log including the time information and text information that indicates the content-related operation related to the each content, the time and text information being displayed in chronological order; and
a program code of initiating the performance of the content-related operation when an instruction is given to the displayed text information.

19. The program according to claim 18, further comprising a program code of displaying an icon that represents a type of content section so as to correspond to the text information when the content-related operation log is displayed.

20. The program according to claim 19, further comprising a program code of displaying map information based on position information included in a content-related operation log for content associated with the displayed text information or icon when an instruction is given to the displayed text information or icon.
